(19) United States
(12) Patent Application Publication
(10) Pub. No.: US 2026/0005563 A1
(43) Pub. Date: Jan. 1, 2026

(54) ROTOR AND METHOD FOR MANUFACTURING ROTOR

(71) Applicant: KABUSHIKI KAISHA TOYOTA JIDOSHOKKI, Kariya-shi (JP)

(72) Inventors: Keiji YANAGI, Kariya-shi (JP); Kensuke IKAI, Kariya-shi (JP)

(73) Assignee: KABUSHIKI KAISHA TOYOTA JIDOSHOKKI, Kariya-shi (JP)

(21) Appl. No.: 19/230,331

(22) Filed: Jun. 6, 2025

(30) Foreign Application Priority Data
Jun. 26, 2024 (JP) 2024-102762
Feb. 26, 2025 (JP) 2025-028951

(51) Int. Cl. H02K 1/276; H02K 15/035

(52) U.S. Cl. CPC H02K 1/276; H02K 15/035

(57) ABSTRACT

A rotor includes a rotor core and a permanent magnet. The rotor core includes a magnet slot extending in an axial direction. The permanent magnet is fitted into the magnet slot and includes an exposed end surface exposed outside the rotor core in the axial direction. The exposed end surface includes a groove. This allows for determination of whether the correct permanent magnet has been attached to the rotor core.

### CROSS-REFERENCE TO RELATED APPLICATIONS

This application is based upon and claims the benefit of priority from prior Japanese Patent Application No. 2024-102762, filed on Jun. 26, 2024, and Japanese Patent Application No. 2025-028951, filed on Feb. 26, 2025, the entire contents of which are incorporated herein by reference.

### BACKGROUND

### 1. Field

The present disclosure relates to a motor and a method for manufacturing a rotor.

### 2. Description of Related Art

A known rotor of a motor includes permanent magnets. Japanese Laid-Open Patent Publication No. 2004-242456 discloses a permanent magnet rotor including a rotor core. The rotor core includes magnet slots that receive permanent magnets. Each permanent magnet includes an end surface exposed from the rotor core. The end surface is marked with paint to indicate the magnetizing direction of the permanent magnet.

The paint applied to the permanent magnet may, however, deteriorate depending on the environment in which the rotor is used. For example, when the permanent magnet is marked with paint to allow for identification of the type of the permanent magnet, it may become difficult to identify the permanent magnet if the paint deteriorates when the rotor is being manufactured.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One general aspect is a rotor including a rotor core and a permanent magnet. The rotor core includes a magnet slot extending in an axial direction. The permanent magnet is fitted into the magnet slot. Further, the permanent magnet includes an exposed end surface exposed to the outside of the rotor core in the axial direction. The exposed end surface includes a groove.

Another general aspect is a method for manufacturing a rotor. The rotor includes a rotor core and a permanent magnet. The rotor core includes a magnet slot extending in an axial direction. The permanent magnet is fitted into the magnet slot. The permanent magnet includes an exposed end surface exposed to the outside of the rotor core in the axial direction. The method includes applying a coating to the exposed end surface, and forming a groove in the exposed end surface. The forming a groove is performed after the applying a coating.

Other features and aspects will be apparent from the following detailed description, the drawings, and the claims.

### BRIEF DESCRIPTION OF THE DRAWINGS

FIG. 1 is a perspective view of a rotor.

FIG. 2 is a perspective view showing a permanent magnet that is arranged in the rotor of FIG. 1.

FIG. 3 is an enlarged perspective view showing an exposed end surface of the permanent magnet of FIG. 2.

FIG. 4 is an enlarged perspective view showing grooves in the exposed end surface of FIG. 3.

FIG. 5 is a schematic diagram illustrating the formation of the grooves by a laser device.

FIG. 6 is a perspective view showing the permanent magnet and a coating.

FIG. 7 is a perspective view showing the permanent magnet, the coating, and slits.

FIG. 8 is an enlarged side view showing the grooves and the slits.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

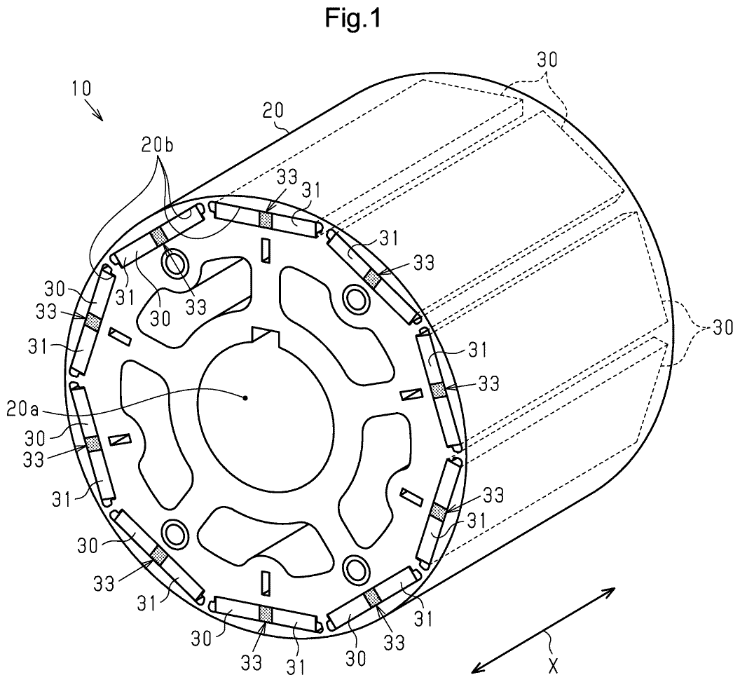

One embodiment of a rotor will now be described with reference to FIGS. 1 to 5.

### Overall Structure of Rotor

As shown in FIG. 1, a rotor 10 includes a rotor core 20 and permanent magnets 30. The rotor 10 forms a motor together with a motor case, a stator, and a shaft (none shown). The motor in accordance with the present embodiment is installed in a vehicle.

### Rotor Core

The rotor core 20 is cylindrical and extends in an axial direction X. The rotor core 20 is formed by laminating steel plates (not shown) in the axial direction X.

The rotor core 20 includes a shaft insertion hole 20a. The shaft insertion hole 20a extends in the axial direction X of the rotor core 20. The shaft insertion hole 20a extends through the rotor core 20 in the axial direction X. The shaft insertion hole 20a extends through the central part of the rotor core 20. A shaft (not shown) is inserted through the shaft insertion hole 20a. The shaft is rotated integrally with the rotor core 20.

The rotor core 20 includes magnet slots 20b. That is, the magnet slots 20b are arranged in the rotor core 20. In the present embodiment, the rotor core 20 includes ten magnet slots 20b. The magnet slots 20b each open at the two opposite end surfaces of the rotor core 20 in the axial direction X at positions located outward from the shaft insertion hole 20a in a radial direction of the rotor core 20. The magnet slots 20b are located outward from the shaft insertion hole 20a in the radial direction of the rotor core 20. The magnet slots 20b extend through the rotor core 20 in the axial direction X.

Each magnet slot 20b is rectangular as viewed in the axial direction X. More specifically, the magnet slot 20b has a rectangular cross section taken in a direction orthogonal to the axial direction X. A longitudinal direction of the magnet slot 20b is orthogonal to the radial direction of the rotor core 20 as viewed in the axial direction X. Each magnet slot 20b is spaced apart from the magnet slots 20b that are adjacent in the circumferential direction of the rotor core 20. The magnet slots 20b are arranged at equal intervals in the circumferential direction of the rotor core 20.

### Permanent Magnets

Each permanent magnet 30 has the form of a plate. The permanent magnets 30 are each fitted into one of the magnet slots 20b. The permanent magnet 30 is fixed to the rotor core 20 by a resin (not shown). In the present embodiment, the rotor core 20 includes ten permanent magnets 30.

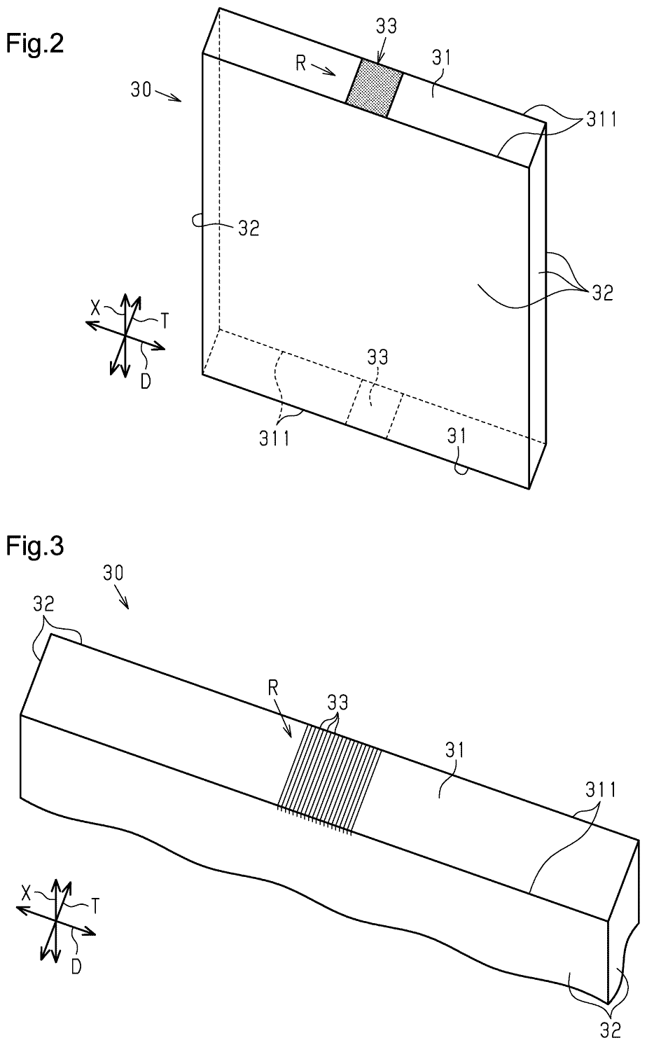

As shown in FIG. 2, each permanent magnet 30 includes two ends in the axial direction X each defining an exposed end surface 31. Thus, each permanent magnet 30 includes two exposed end surfaces 31. The exposed end surfaces 31 are opposite surfaces of the permanent magnet 30 in the axial direction X. FIG. 1 shows only one of the two exposed end surfaces 31 in each permanent magnet 30.

As shown in FIG. 1, the permanent magnets 30 are arranged in the rotor core 20, and the exposed end surfaces 31 are exposed to the outside of the rotor core 20. That is, each permanent magnet 30 includes the exposed end surfaces 31 that are exposed to the outside of the rotor core 20 in the axial direction X. As shown in FIG. 2, each permanent magnet 30 includes four magnet side surfaces 32. The magnet side surfaces 32 are outer surfaces of the permanent magnet 30 that are discrete from the exposed end surfaces 31. In the permanent magnet 30, the two exposed end surfaces 31 are connected by the four magnet side surfaces 32. The outer surfaces of the permanent magnet 30 include the two exposed end surfaces 31 and the four magnet side surfaces 32.

The magnet side surfaces 32 of the permanent magnet 30 face the surfaces defining the corresponding magnet slot 20b. Thus, only the exposed end surfaces 31 of the permanent magnet 30 are exposed to the outside of the rotor core 20.

As shown in FIGS. 1 and 2, each exposed end surface 31 is a rectangular surface orthogonal to the axial direction X. As shown in FIG. 2, the exposed end surface 31 includes two edges 311 extending in a longitudinal direction D as viewed in the axial direction X. Each permanent magnet 30 is a plate body having a thickness in a thickness direction T orthogonal to the axial direction X and to the longitudinal direction D. The longitudinal direction D is orthogonal to the axial direction X and to the thickness direction T of the permanent magnet 30.

### Grooves

As shown in FIG. 2, each permanent magnet 30 includes one or more grooves 33 in each exposed end surface 31. As shown in FIG. 3, the permanent magnet 30 includes the one or more grooves 33 in a groove region R that is defined in the exposed end surface 31. The groove region R is located in the exposed end surface 31 at a central part with respect to the longitudinal direction D. In the exposed end surface 31, the groove region R extends from one edge 311 to the other edge 311 in the thickness direction T.

As shown in FIG. 3, each exposed end surface 31 of the permanent magnet 30 includes the grooves 33. The grooves 33 are formed in the groove region R. In the present embodiment, each exposed end surface 31 of the permanent magnet 30 includes twenty grooves 33.

In each exposed end surface 31, the grooves 33 extend straight from one edge 311 toward the other edge 311. More specifically, the grooves 33 extend in a direction orthogonal to the axial direction X and to the longitudinal direction D. Each groove 33 includes two ends with respect to the direction in which the groove 33 extends. The two edges are connected to the edges 311. Each groove 33 extends in the thickness direction T of the permanent magnet 30.

The grooves 33 formed in the exposed end surface 31 are parallel to one another. More specifically, the grooves 33 are parallel and arranged next to one another in the longitudinal direction D. Thus, the permanent magnet 30 includes the grooves 33 that are parallel and arranged next to one another in the longitudinal direction D.

The grooves 33 are formed in the exposed end surface 31 so that the interval between adjacent grooves is 2 mm. The grooves 33 formed in the exposed end surface 31 each have a width of 0.1 mm in the longitudinal direction D.

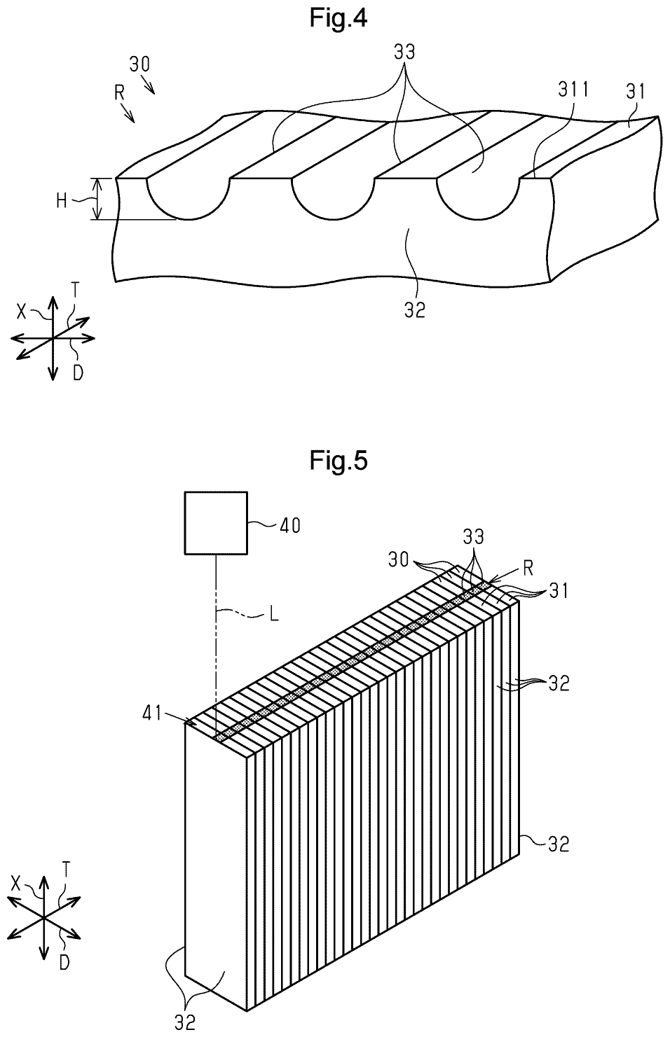

As shown in FIG. 4, the grooves 33 are open toward the outside of the permanent magnet 30 in the exposed end surface 31. The grooves 33 are each recessed in the axial direction X from the exposed end surface 31. In FIG. 4, the distance from the exposed end surface 31 to the deepest point of each groove 33 in the axial direction X is depicted as the depth H of the groove 33. The depth H of each groove 33 is set in a range from 2 μm to 200 μm, inclusive. Thus, the depth H of the grooves 33 in the axial direction X is preferably in the range from 2 μm to 200 μm, inclusive. The depth His preferably in a range from 2 μm to 100 μm, inclusive, and further preferably in a range from 2 μm to 30 μm, inclusive.

### Method for Forming Grooves, and Method for Identifying Permanent Magnets

As shown in FIG. 5, a laser device 40 is used to form the grooves 33 in the permanent magnets 30. The laser device 40 is configured to irradiate the exposed end surface 31 of each permanent magnet 30 with a laser beam L and remove parts of the permanent magnet 30. That is, the grooves 33 are formed by processing the exposed end surface 31 with the laser beam L.

The method for forming the grooves 33 in the permanent magnet 30 with the laser device 40 will now be described with reference to FIG. 5. The laser device 40 forms the grooves 33 in the permanent magnets 30. The permanent magnets 30 are all identical in shape. More specifically, the permanent magnets 30 are all identically dimensioned in each of the axial direction X, the longitudinal direction D, and the thickness direction T.

Prior to the formation of the grooves 33, the permanent magnets 30 are arranged next to one another in the thickness direction T to be parallel to one another. The permanent magnets 30 are arranged so that each of the two edges, which extend in the longitudinal direction D, of a permanent magnet 30 is arranged along the same line as one of the edges of an adjacent permanent magnet. That is, an edge of a permanent magnet 30 abuts an edge of a permanent magnet 30 that is adjacent in the thickness direction T. The set of the permanent magnets 30 includes two ends in the axial direction, and each of the two ends defines a processed surface 41 including the exposed end surfaces 31 that are arranged next to one another in the thickness direction T. The exposed end surfaces 31 of the permanent magnets 30 in each processed surface 41 all face the same direction.

As shown in FIG. 5, the laser device 40 irradiates one of the processed surfaces 41 with the laser beam L. In other words, the laser device 40 irradiates the exposed end surfaces 31 at one side of the permanent magnets 30, which are arranged as described above, with the laser beam L. The grooves 33 are formed in the portion of the exposed end surfaces 31 irradiated by the laser beam L. The laser device 40 linearly moves the irradiation position of the laser beam L from one edge toward the other edge of the processed surface 41 in the thickness direction T. In other words, the laser device 40 linearly moves the laser beam L in the thickness direction T to traverse the set of the permanent magnets 30. The laser device 40 irradiates the set of the permanent magnets 30 with the laser beam L twenty times to form the twenty grooves 33 in the set of the permanent magnets 30.

The laser device 40 forms the grooves 33 as described above in each of the two exposed end surfaces 31 of each permanent magnet 30. In the present embodiment, the laser device 40 forms forty grooves 33 in each permanent magnet 30.

A method for identifying the permanent magnets 30 in a state in which the permanent magnets 30 are attached to the rotor core 20 will now be described. A worker manufacturing the rotor 10 uses this method to identify the permanent magnets 30. The worker identifies the permanent magnets 30 to determine whether the correct permanent magnets 30 are attached to the rotor core 20.

The identification of the permanent magnets 30 is performed using images captured by a camera (not shown). In the present embodiment, each permanent magnet 30 is identified by capturing a contour image of the permanent magnet 30. The contour image as referred to in this specification is an image acquired by combining a number of images captured by illuminating the grooves 33 with light from different angles. The contour image shows, in emphasis, irregularities formed by the grooves 33 in the exposed end surface 31. The worker determines from the contour image whether the permanent magnet 30 includes the grooves 33.

### Advantages of Embodiment

The advantages and operation of the present embodiment will now be described.

(1-1) Each permanent magnet 30 is fitted into the corresponding magnet slot 20b in a state in which the exposed end surfaces 31 are exposed to the outside of the rotor core 20. For example, the grooves 33 having an identification functionality are formed in advance in the exposed end surfaces 31 of the permanent magnets 30 that are to be attached to the rotor core 20. The identification functionality allows for identification of each permanent magnet 30 attached to the rotor core 20. The worker uses the grooves 33 as a marking reference when attaching the permanent magnets 30 to the rotor core 20. Further, the worker can determine after the permanent magnets 30 are attached to the rotor core 20 whether the correct permanent magnets 30 have been attached to the rotor core 20. In other words, the worker can determine by checking the grooves 33 whether the combination of the permanent magnets 30 and the rotor core 20 is correct. The rotor 10 allows for identification of the permanent magnets 30 in a state in which the permanent magnets 30 are attached to the rotor core 20. This would not be possible if, for example, the grooves 33 were to be formed in a surface of the permanent magnet 30 other than the exposed end surfaces 31.

(1-2) The grooves 33 are used as a marking in the permanent magnets 30. Thus, in contrast to when, for example, marking the permanent magnet 30 with paint, deterioration of the mark will be limited. For example, the rotor 10 is used in a motor installed in a vehicle and thus operated in an environment in which the temperature is higher than that of the environment of a motor installed in air conditioning facility. Deterioration of a painted mark progresses more quickly in a high-temperature environment than a low-temperature environment. Thus, when the rotor 10 of a motor installed in a vehicle uses the grooves 33 for marking instead of paint, deterioration of the marking can be further delayed. The rotor 10 avoids a situation in which identification of the permanent magnets 30 is difficult due to deterioration of the marking during manufacturing or use of the rotor 10. As described above, the rotor 10 facilitates identification of the permanent magnets 30 in a state in which the permanent magnets 30 are attached to the rotor core 20.

(1-3) The exposed end surfaces 31 of each permanent magnet 30 is exposed to the outside at the two ends of the rotor core 20 in the axial direction X. For example, identification of the permanent magnet 30 through the grooves 33 may be performed using only one of the two ends of the rotor core 20. Even in this case, with the permanent magnet 30 of the structure described above, the direction in which the permanent magnet 30 is inserted into the rotor core 20 does not have to be adjusted so that the grooves 33 are exposed. Thus, the worker attaching the permanent magnets 30 to the rotor core 20 does not have to arrange the permanent magnets 30 so that the permanent magnets 30 are inserted into the rotor core 20 from the same side. In other words, the rotor 10 can be manufactured more efficiently than when the grooves 33 are included on only one end of the permanent magnet 30.

(1-4) In the present embodiment, the grooves 33 are formed in the exposed end surfaces 31 in a state in which the permanent magnets 30 are arranged in parallel next to one another so that the thickness direction T is the same in each permanent magnet 30 and so that the exposed end surfaces 31 of the permanent magnets 30 face the same direction in a state arranged next to one another. Straight grooves are formed in every one of the exposed end surfaces 31 that are arranged next to one another facing the same direction. This allows the grooves 33 to be formed simultaneously in the exposed end surfaces 31 of the permanent magnets 30 Thus, the rotor 10 facilitates the formation of the grooves 33 in the permanent magnets 30.

(1-5) The depth H of the grooves 33 is in the range from 2 μm to 200 μm, inclusive. This limits the adverse effects that volume reduction would have on the magnetic characteristics of the permanent magnet 30, while allowing the permanent magnets 30 to include the grooves 33 used as markings.

(1-6) The permanent magnets 30 are identified using the grooves 33. Thus, even if damage or the like is inflicted to some of the grooves 33, the other grooves 33 can be used to identify the permanent magnets 30. That is, even if damage or the like is inflicted to the exposed end surface 31, the rotor 10 allows for identification of the permanent magnets 30 with the grooves 33.

(1-7) The grooves 33 are formed by the laser beam L in the exposed end surfaces 31 of the permanent magnets 30. This allows the depth and width of the grooves 33 to be adjusted with higher accuracy than when, for example, machining the permanent magnet 30 to form the grooves 33.

### Second Embodiment

One embodiment of a rotor and a method for manufacturing a rotor will now be described with reference to FIGS. 1, 5, and 6 to 8.

The rotor manufactured by the method in accordance with the present embodiment differs from the rotor 10 of the first embodiment in that the permanent magnet 30 includes a coating 50 and in that the coating 50 includes slits 51. Otherwise, the rotor in accordance with the present embodiment has the same structure as the rotor 10 of FIG. 1. In the description hereafter, components that are the same as the corresponding components of the rotor 10 in accordance with the first embodiment will not be described.

The rotor in accordance with the present embodiment will be referred to as the rotor 10 in the same manner as the first embodiment. In the rotor 10 in accordance with the first embodiment, same names and reference numbers are given to those components that are the same as the corresponding components of the first embodiment. When referring to FIG. 1 in the description of the present embodiment, the coating 50 and the slits 51 that are shown in FIG. 8 are not shown in FIG. 1. Further, when referring to FIG. 5 in the description of the present embodiment, the coating 50, the slits 51, and a slit region R2 that are shown in FIG. 8 are not shown in FIG. 5.

### Overall Structure of Rotor

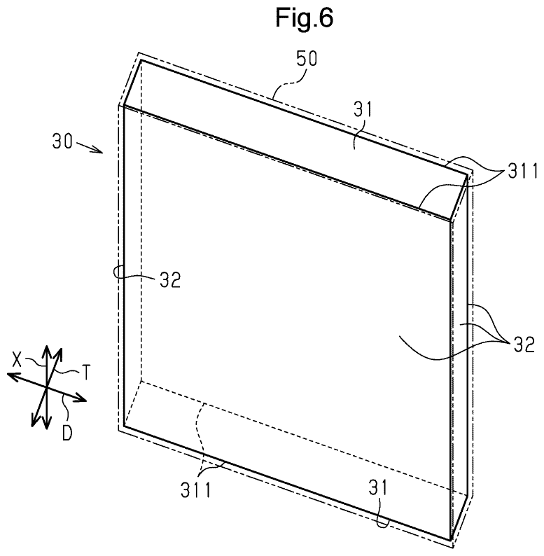

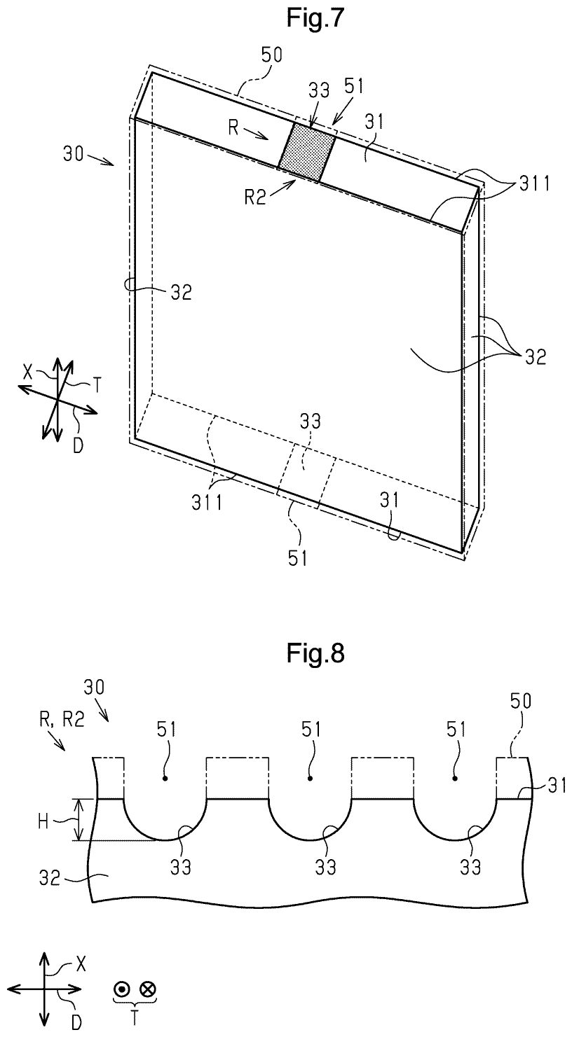

As shown in FIGS. 6 and 7, the coating 50 covers every surface of the permanent magnet 30. More specifically, the permanent magnet 30 includes the coating 50 on the two exposed end surfaces 31 and the four magnet side surfaces 32. The coating 50 is formed by, for example, an oil-based or epoxy-based rust inhibitor. The coating 50, however, does not necessarily have to be formed by an oil-based or epoxy-based rust inhibitor. The coating 50 may be, for example, a chemical conversion coating including zirconium. The coating 50 is formed on the surfaces of the permanent magnet 30 by performing a surface treatment on the permanent magnet 30. The coating 50 is applied to the permanent magnet 30 to improve the rustproof and anticorrosion characteristics of the permanent magnet 30. In FIGS. 6 to 8, the coating 50 is depicted in double-dashed lines with an exaggerated thickness to simplify illustration.

As shown in FIG. 8, the coating 50 includes the slits 51. The slits 51 are formed in the coating 50, which is arranged on the exposed end surface 31. In FIG. 7, the region where the slits 51 are formed in the coating 50 is referred to as the slit region R2. The shape and size of the slits 51 shown in FIG. 8 vary in accordance with the specific shape and size of the coating 50, which is depicted by the double-dashed lines. In FIG. 8, the coating 50 is shown having an exaggerated thickness. Thus, the size of the slits 51 in the axial direction X are also shown in an exaggerated manner.

The slits 51 are formed by removing parts of the coating 50, which covers the exposed end surface 31. The slits 51 are formed by removing parts of the coating 50 over the entire thickness of the coating 50. Thus, the exposed end surface 31 includes parts that are not covered by the coating 50. The exposed end surface 31 includes parts exposed to the outside of the coating 50 by the slits 51.

The exposed end surface 31 includes parts covered by the coating 50 and parts that are not covered by the coating 50. In other words, the exposed end surface 31 includes parts where the coating 50 is located directly above the exposed end surface 31 and parts where the slits 51 are located directly above the exposed end surface 31. In the exposed end surface 31, parts that are covered by the coating 50 and parts that are not covered by the coating 50 are arranged alternately in the longitudinal direction D.

The permanent magnet 30 includes the coating 50 applied to the exposed end surface 31 at parts where the grooves 33 are not formed. In other words, the permanent magnet 30 includes the coating 50 at parts of the exposed end surface 31 where the grooves 33 are not formed. The coating 50 covers parts of the exposed end surface 31 where the grooves 33 are not formed. Each slit 51 is arranged next to one of the grooves 33 in the axial direction X.

In the exposed end surface 31, the grooves 33 are arranged next to one another in the longitudinal direction D. Adjacent grooves 33 are spaced apart from each other in the longitudinal direction D. The coating 50 is arranged on the exposed end surface 31 between adjacent grooves 33.

### Method for Manufacturing Rotor

The method for manufacturing the rotor 10 includes a coating formation step, a groove formation step, a coupling step, and an inspection step. Each step will now be described.

### Coating Formation Step

Referring to FIG. 6, the coating formation step forms the coating 50 on the surfaces of the permanent magnet 30. More specifically, the coating formation step forms the coating 50 on the exposed end surfaces 31 and the magnet side surfaces 32 of each permanent magnet 30.

The coating formation step includes an immersion process in which the entire permanent magnet 30 is immersed in a solution. In the coating formation step, the immersion of the permanent magnet 30 in the solution forms the coating 50 on the outer surface of the permanent magnet 30. The solution used in the coating formation step includes the components composing the coating 50. The coating formation step also includes pre-processing for degreasing and washing the permanent magnet 30 before the immersion process, and post-processing for washing and drying the permanent magnet 30 after the immersion process. The pre-processing and post-processing will not be described in detail.

In the coating formation step, subsequent to post-processing, a film may be applied to the surfaces of the permanent magnet 30 to improve the anticontamination characteristics. In this case, the coating 50 includes the film formed on the permanent magnet 30.

The coating 50 covers the entire permanent magnet 30. More specifically, the coating 50 covers the two exposed end surfaces 31 and the four magnet side surfaces 32.

### Groove Formation Step

The groove formation step forms the grooves 33 in the exposed end surface 31 of the permanent magnet 30. The groove formation step is performed after the coating formation step. More specifically, the groove formation step forms the grooves 33 in the permanent magnet 30 to which the coating 50 has been applied in the coating formation step. In the groove formation step, the grooves 33 are formed by the laser beam L. The groove formation step is performed by the laser device 40 shown in FIG. 5. The laser device 40 irradiates the exposed end surface 31, which is covered by the coating 50, with the laser beam L in the axial direction X. The laser beam L removes parts of the permanent magnet 30 and the coating 50.

As shown in FIG. 8, the parts removed from the permanent magnet 30 and the coating 50 by the laser device 40 shown in FIG. 5 produces openings in the axial direction X. As a result, the grooves 33 are formed in the exposed end surface 31 of the permanent magnet 30, and the slits 51 are formed in the coating 50 next to the grooves 33 in the axial direction X.

The groove formation step forms the grooves 33 in the permanent magnet 30 with the laser beam L so that the depth H of the grooves 33 is in a range from 2 μm to 200 μm, inclusive. The depth H of the groove 33 does not include the thickness of the coating 50. The depth H of the grooves 33 in the axial direction X is preferably in the range from 2 μm to 200 μm, inclusive. The depth H is further preferably in a range of 2 μm to 100 μm, inclusive, and even more preferably in a range from 2 μm to 30 μm, inclusive. In FIG. 8, the thickness of the coating 50 is exaggerated. The thickness of the coating 50 is less than the depth H and approximately 1 μm.

As shown in FIG. 5, the groove formation step is performed on the permanent magnets 30. The groove formation step differs from the first embodiment in that the coating 50 is formed on each permanent magnet 30. Otherwise, the laser device 40 forms the grooves 33 in each of the permanent magnets 30 in the same manner. Thus, the formation of the grooves 33 and the slits 51 in the permanent magnets 30 with the laser device 40 in the groove formation step will not be described.

### Coupling Step and Inspection Step

The coupling step couples the permanent magnets 30, in which the grooves 33 are formed, to the rotor core 20 shown in FIG. 1. The coupling step is performed after the groove formation step. In the coupling step, the permanent magnets 30 are coupled to the magnet slots 20b of the rotor core 20 so that the exposed end surfaces 31 are exposed to the outside of the rotor core 20.

In the inspection step, the worker manufacturing the rotor 10 identifies the permanent magnets 30 that are attached to the rotor core 20. The inspection step is performed to determine whether the correct permanent magnets 30 are attached to the rotor core 20. In the inspection step, the worker identifies the permanent magnets 30 in the same manner as the first embodiment. Thus, the identification of the permanent magnets 30 in the inspection step will not be described in detail.

### Advantages of Embodiment

The advantages and operation of the present embodiment will now be described.

(2-1) The method for manufacturing the rotor 10 includes the coating formation step and the groove formation step. The groove formation step is performed after the coating formation step. This forms the grooves 33 in the permanent magnet 30 while leaving the coating 50 on the exposed end surface 31 at the parts where the grooves 33 are not formed. In comparison with when the groove formation step is performed before the coating formation step, the method for manufacturing the rotor 10 avoids a situation in which the grooves 33 are covered by the coating 50. If the grooves 33 were to be covered by the coating 50, the permanent magnets 30 will be difficult to identify. Such a situation is avoided. Thus, the method for manufacturing the rotor 10 facilitates identification of the permanent magnets 30 that are attached to the rotor core 20.

(2-2) The method for manufacturing the rotor 10 irradiates the exposed end surface 31 of the permanent magnet 30 with the laser beam L to form the grooves 33. The method for manufacturing the rotor 10 allows the depth H of the groove 33 to be adjusted more accurately than when the grooves 33 are formed in the permanent magnet 30 through, for example, grinding.

(2-3) The permanent magnet 30 includes the coating 50 on parts of the exposed end surface 31 where the grooves 33 are not formed. Further, the grooves 33 are exposed to the outside of the coating 50. Thus, in the permanent magnet 30, the grooves 33 are not embedded in the coating 50. Since the grooves 33 are not embedded in the coating 50, it is not difficult to identify the permanent magnet 30 with the grooves 33. As described above, the coating 50 is applied to each exposed end surface 31 at parts where the grooves 33 are not formed. Thus, the rotor 10 facilitates identification of the permanent magnet 30 attached to the rotor core 20.

(2-4) The permanent magnet 30 exposes the grooves 33 to the outside of the coating 50, and includes the coating 50 on the exposed end surface 31 between adjacent grooves 33. In a comparative example, the permanent magnet 30 includes the grooves 33 in the exposed end surface 31, and does not include the coating 50 between adjacent grooves 33. In contrast with the comparative example, the permanent magnet 30 limits reduction in the area of the exposed end surface 31 covered by the coating 50, while exposing the grooves 33 to the outside of the coating 50. Thus, the rotor 10 maintains the rustproof characteristics of the permanent magnet 30 provided by the coating 50, while allowing for identification of the permanent magnet 30 with the grooves 33.

### Modified Examples

The above embodiments may be modified as described below. The above embodiments and the modified examples described below may be combined as long as there is no technical contradiction.

The laser beam L does not have to be used to form the grooves 33 in the exposed end surface 31. For example, the grooves 33 may be formed by grinding the exposed end surface 31.

The grooves 33 do not have to be parallel and arranged next to one another in the longitudinal direction D. For example, the grooves 33 may intersect one another in the exposed end surface 31.

The depth H of the grooves 33 may be less than 2 μm. Further, the depth H of the grooves 33 may be greater than 200 μm. The depth H of the grooves 33 is not limited as long as it is in a range allowing for the display of a contour image.

In the exposed end surface 31, there is no limitation to the distance between adjacent grooves 33. In the exposed end surface 31, the edges of two adjacent ones of the grooves 33 may be connected.

The number of the grooves 33 is not limited to twenty. Further, each exposed end surface 31 of the permanent magnet 30 does not have to include multiple grooves 33. That is, each exposed end surface 31 of the permanent magnet 30 may include any number of grooves 33 that is one or greater.

The grooves 33 do not have to extend straight. For example, the grooves 33 may extend in a curved manner from one edge 311 toward the other edge 311.

One end of each groove 33 may be connected to an edge 311 of the exposed end surface 31 that extends in the longitudinal direction D, and the other end of the groove 33 may be connected to an edge of the exposed end surface 31 extending in a direction orthogonal to the longitudinal direction D.

The grooves 33 do not have to extend straight from one edge 311 to the other edge 311. For example, the exposed end surface 31 includes two edges extending in a direction orthogonal to the longitudinal direction D, and the grooves 33 may extend from one of the edges toward the other one of the edges. In other words, the grooves 33 may extend in the longitudinal direction D.

The exposed end surface 31 does not have to be rectangular. For example, the exposed end surface 31 may be a parallelogram including the two edges 311 extending in the longitudinal direction D.

The permanent magnet 30 and the exposed end surface 31 are not limited to the shapes described and illustrated in the above embodiments. For example, the exposed end surface 31 may be curved in the circumferential direction of the rotor core 20. The permanent magnet 30 may be a post-like body including the exposed end surface 31 that is curved in the circumferential direction of the rotor core 20. In this case, the magnet slots 20b are shaped in conformance with the permanent magnets 30.

The grooves 33 do not have to be formed in both ends of the permanent magnet 30 in the axial direction X. In other words, the grooves 33 may be formed in only one end of the permanent magnet 30 in the axial direction X. In this case, the permanent magnets 30 are inserted into the magnet slots 20b so that the grooves 33 are exposed from the same end of the rotor core 20.

The motor that includes the rotor 10 does not have to be installed in a vehicle. The motor may be installed in any equipment.

The exposed end surface 31, which is exposed from the rotor core 20, may be covered by a component other than that of the rotor core 20 such as an end plate. The exposed end surface 31 of the permanent magnet 30 may be covered by any member as long as it is not covered by the rotor core 20.

In the permanent magnet 30, the coating 50 does not have to entirely cover the part of the exposed end surface 31 corresponding to the groove region R. More specifically, in the exposed end surface 31, the parts between adjacent grooves 33 do not have to be covered by the coating 50. In this case, the permanent magnet 30 includes the coating 50 on the exposed end surface 31 only at the two sides of the groove region R in the longitudinal direction D. The coating 50 may be arranged on the exposed end surface 31 at any location where the grooves 33 are not formed.

The groove formation step does not have to use the laser beam L to form the grooves 33 in the exposed end surface 31. For example, the exposed end surface 31 may be grinded to form the grooves 33 in the groove formation step.

The method for manufacturing the rotor 10 may include a step for processing the permanent magnet 30 after the coating formation step and before the groove formation step. In the method for manufacturing the rotor 10, as long as the groove formation step is performed after the coating formation step, the groove formation step does not have to be performed immediately after the coating formation step. One example of a step for processing the permanent magnet 30 is a step for measuring the thickness of the coating 50 formed on the permanent magnet 30.

The coating formation step does not have to immerse the permanent magnet 30 in a solution to form the coating 50 on the permanent magnet 30. For example, the solution may be sprayed onto the permanent magnet 30 to form the coating 50 on the permanent magnet 30. Any surface processing may be performed on the permanent magnet 30 to form the coating 50.

The coating formation step may form the coating 50 on only the exposed end surface 31. In other words, the coating formation step does not have to form the coating 50 on the four magnet side surfaces 32.

In the inspection step, the worker manufacturing the rotor 10 may visually identify the permanent magnets 30 attached to the rotor core 20. More specifically, the worker manufacturing the rotor 10 may visually check the permanent magnets 30 to directly determine whether the correct permanent magnets 30 are attached to the rotor core 20. In the second embodiment, the permanent magnet 30 exposes the grooves 33 to the outside of the coating 50 through the slits 51 and includes the coating 50 applied to parts where the grooves 33 are not formed. As a result, in the exposed end surface 31 of the permanent magnet 30, the grooves 33 differ in color tone from the coating 50 as viewed from the worker. Since the permanent magnet 30 includes the coating 50 applied to parts where the grooves 33 are not formed, the worker can identify the permanent magnet 30 through visual confirmation more readily than when the grooves 33 are covered by the coating 50.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rotor, comprising:
a rotor core including a magnet slot extending in an axial direction; and
a permanent magnet fitted into the magnet slot and including an exposed end surface exposed to the outside of the rotor core in the axial direction,
wherein the exposed end surface includes a groove.

2. The rotor according to claim 1, wherein
the magnet slot extends through the rotor core in the axial direction, and
the exposed end surface is one of two exposed end surfaces defined respectively by two ends of the permanent magnet in the axial direction, and each of the exposed end surfaces includes the groove.

3. The rotor according to claim 1, wherein
the exposed end surface includes two edges extending in a longitudinal direction as viewed in the axial direction,
the permanent magnet is a plate-like body and has a thickness in a direction orthogonal to both the axial direction and the longitudinal direction, and
the groove extends straight from one of the edges toward the other one of the edges.

4. The rotor according to claim 1, wherein the groove has a depth in the axial direction in a range from 2 μm to 200 μm, inclusive.

5. The rotor according to claim 3, wherein the groove is one of parallel grooves arranged next to each other in the longitudinal direction.

6. The rotor according to claim 1, wherein the groove is formed by processing the exposed end surface with a laser beam.

7. The rotor according to claim 1, wherein the permanent magnet includes a coating applied to a part of the exposed end surface where the groove is not formed.

8. The rotor according to claim 7, wherein
the groove is one of multiple grooves,
the coating is applied to the exposed end surface between adjacent ones of the grooves.

9. A method for manufacturing a rotor including a rotor core and a permanent magnet, the rotor core including a magnet slot extending in an axial direction, and the permanent magnet being fitted into the magnet slot and including an exposed end surface exposed to the outside of the rotor core in the axial direction, the method comprising:
applying a coating to the exposed end surface; and
forming a groove in the exposed end surface,
wherein the forming a groove is performed after the applying a coating.

10. The method according to claim 9, wherein the forming a groove includes using a laser beam to form the groove.
